(19) United States
(12) Patent Application Publication
(10) Pub. No.: US 2014/0047083 A1
(43) Pub. Date: Feb. 13, 2014

(54) ADMINISTRATION INFORMATION GENERATION METHOD, ADMINISTRATION INFORMATION GENERATION PROGRAM, AND ADMINISTRATION INFORMATION GENERATION DEVICE

(71) Applicants: Yujiro Ichikawa, Tokyo (JP); Yoshifumi Takamoto, Tokyo (JP); Takashi Tameshige, Tokyo (JP)

(72) Inventors: Yujiro Ichikawa, Tokyo (JP); Yoshifumi Takamoto, Tokyo (JP); Takashi Tameshige, Tokyo (JP)

(73) Assignee: HITACHI, LTD., Tokyo (JP)

(21) Appl. No.: 14/112,643

(22) PCT Filed: May 10, 2011
(86) PCT No.: PCT/JP2011/060726

§ 371 Date: Oct. 18, 2013

(51) Int. Cl. H04L 12/24

(52) U.S. Cl. CPC H04L 41/08
USPC 709/220

(57) ABSTRACT

The present invention relates to a management information generation method for a management information generation apparatus (20) in a system (1) including a plurality of managed objects (10, 12, 13, 14), to generate management information for the managed objects (10, 12, 13, 14). A control part (21) of the management information generation apparatus (20) stores configuration information (300) of the managed objects (10, 12, 13, 14) in the system (1), as well as management information (100) previously configured for some managed objects (10, 12, 13, 14) of the plurality of managed objects (10, 12, 13, 14) into a storage part (28). A configuration part (21) of the management information generation apparatus (20) uses the configuration information (300) and the previously configured management information (100) to generate the management information (100) for the other managed objects (10, 12, 13, 14) of the plurality of managed objects (10, 12, 13, 14).

### TECHNICAL FIELD

The present invention relates to a technique such as an information management method for generating management information to control connection to a server and usage of it.

### BACKGROUND ART

With the recent development of large-scale system, the number of servers and administrators has increased and the type of server has changed. Further, the number of management products for managing these servers has also increased, so that the form of the system has been expanded and complicated.

### CITATION LIST

Patent Literature 1: Japanese Patent Application Laid-Open No. 2008-15625

### SUMMARY OF INVENTION

### Technical Problem

Under these circumstances, the user may use a plurality of servers. Here, in order to prevent the influence of user error from spreading and to prevent the user from viewing unnecessary information, it is necessary to configure permissions that match the role of the user with respect to each server (see Patent Literature 1). However, the configuration process should take into account the expansion of the system as well as the hierarchical relationship between servers. Thus, there is a problem that the configuration process is complicated and time-consuming.

The present invention has been made in the background of these circumstances and aims to effectively generate management information appropriate for a plurality of servers.

### Solution to Problem

In order to solve the problem described above, the present invention is a management information generation method for a management information generation apparatus in a system including a plurality of managed objects, to generate management information to the managed objects. A control part of the management information generation apparatus stores configuration information of the managed objects in the system, as well as management information previously configured for some managed objects of the plurality of managed objects, into a storage part. A configuration part of the management information generation apparatus generates the management information for the other managed objects of the plurality of managed objects by using the configuration information and the previously configured management information.

Other solutions will be described accordingly with reference to exemplary embodiments.

### Advantageous Effects of Invention

According to the present invention, it is possible to effectively generate management information appropriate for a plurality of servers.

### BRIEF DESCRIPTION OF DRAWINGS

FIG. 1 is an overall block diagram of a management information generation system according to a first embodiment.

FIG. 2 is a block diagram of a management server (management information generation apparatus) according to the first embodiment.

FIG. 3 is a block diagram of a physical server and a disk array apparatus according to the first embodiment.

FIG. 4 is a block diagram of the physical server with virtual servers, and the disk array apparatus according to the first embodiment.

FIG. 5 is a view of the use state of the management information generation system according to the first embodiment.

FIG. 6 is a view of an example of a use state table according to the first embodiment.

FIG. 7 is a view of an example of a permission definition table according to the first embodiment.

FIG. 8 is a view of an example of a configuration information table according to the first embodiment.

FIG. 9 is a flow chart of the process operation of the management server (management information generation apparatus) according to the first embodiment.

FIG. 10 is a view of an example of a propagation table according to a second embodiment.

FIG. 11 is a flow chart of the process operation of a management server (management information generation apparatus) according to a second embodiment.

FIG. 12 is a view of an example of a group definition table according to a third embodiment.

FIG. 13 is a flow chart of the process operation of a management server (management information generation apparatus) according to the third embodiment.

FIG. 14 is a flow chart of the process operation of a management server (management information generation apparatus) according to a fourth embodiment.

### DESCRIPTION OF EMBODIMENTS

### First Embodiment

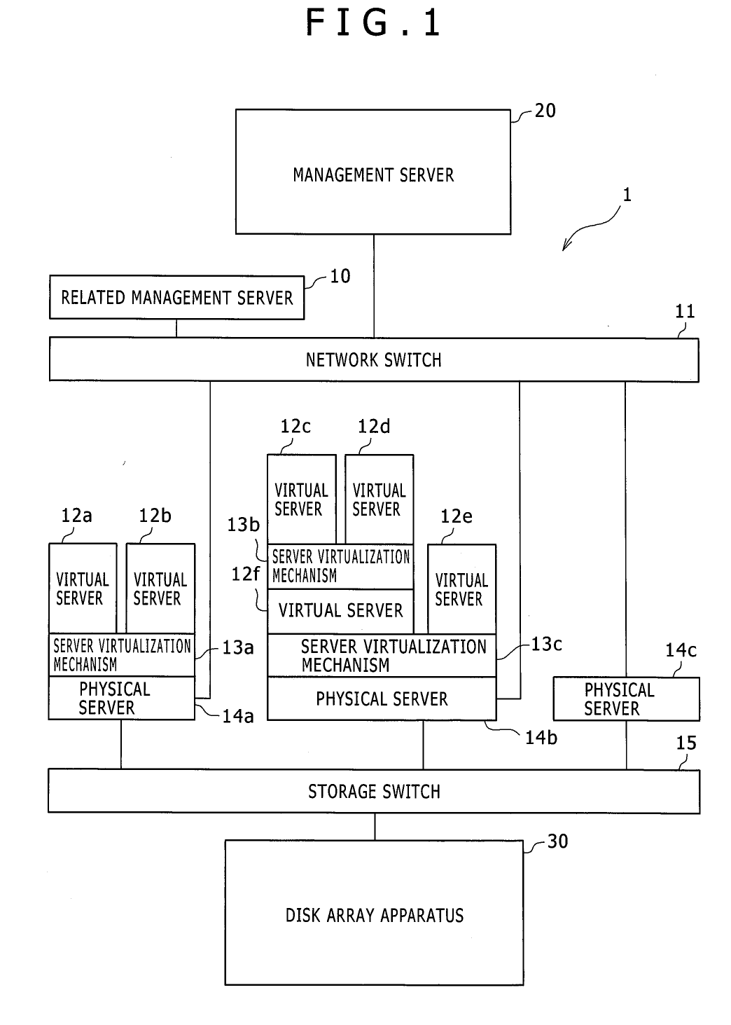

Hereinafter, a first embodiment of the present invention will be described with reference to FIGS. 1 to 9. Note that like reference numerals designates like or corresponding parts throughout the different views, and the description thereof will be omitted.

FIG. 1 is an overall block diagram of a management information generation system 1 according to the embodiment.

As shown in FIG. 1, the management information generation system 1 includes a management server (management information generation apparatus) 20, physical servers 14 (14a, 14b, 14c), a network switch 11, a storage switch 15, a disk array apparatus 30, and a related management server 10. The management information generation system 1 includes one or more of each of the components.

The management server 20 connects to the physical server 14, the disk array apparatus 30, and the related management server 10 through the network switch 11.

The physical server 14 connects to the other physical servers 14, the management server 20, the disk array apparatus 30, and the related management server 10 through the network switch 11. Further, the physical servers 14 connect to the disk array apparatus 30 through the storage switch 15.

The network switch 11 is the network equipment including a network switch, a router, a load balancer, a firewall, and the like.

The disk array apparatus 30 includes FC (Fiber Channel) and LAN (Local Area Network) interfaces. The disk array apparatus 30 is a storage system including one or more disks used by the management server 20, each of the physical servers 14, and the related management server 10.

The related management server 10 works with the management server 20 so that the management server 20 connects to each part of the management information generation system 1. The related management server 10 contains functions to allow the management server 20 to perform information acquisition, state change, configuration change, and the like, with respect to each part of the management information generation system 1. Further, the related management server 10 also includes external interfaces (API (Application Program Interface), CLI (Command Line Interface), and the like). The management sever 20 can perform the functions of the related management server 10 through the network and the like.

Virtual servers 12 (12a, 12b, 12c, 12d, 12e, 12f) and server virtualization mechanisms 13 (13a, 13b, 13c) will be described below.

It is to be noted that the related management server 10, the virtual server 12, the server virtualization mechanism 13, and the physical server 14 are collectively referred to as “each server” as appropriate.

### Configuration of the Management Server 20

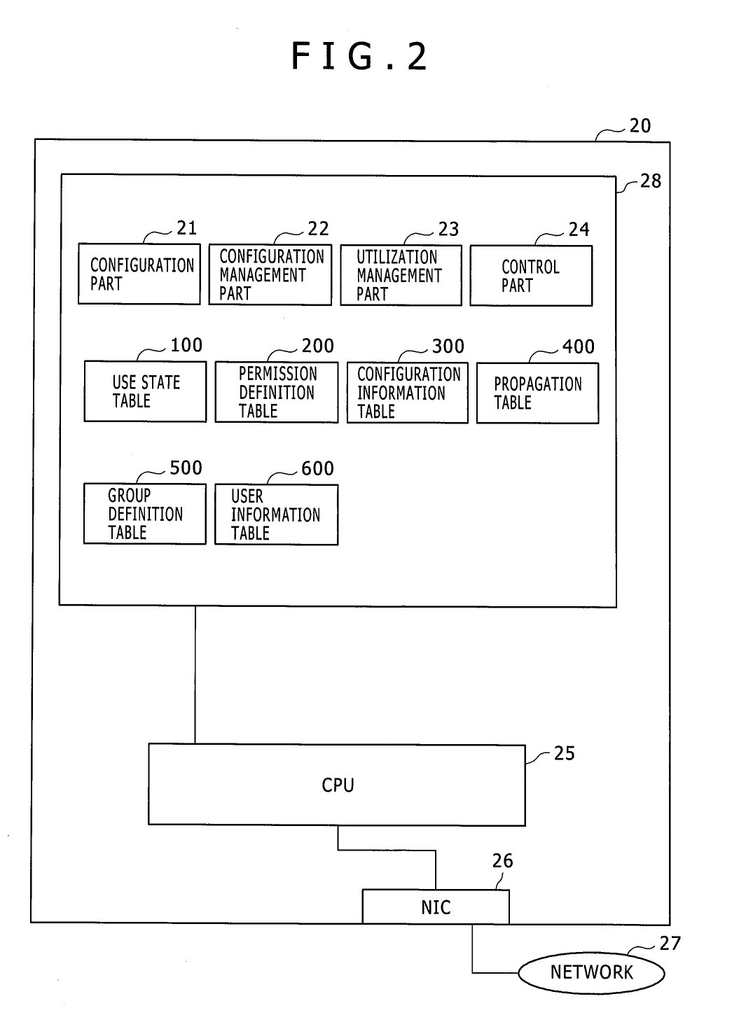

Next, the configuration of the management server 20 will be described with reference to FIG. 2.

As shown in FIG. 2, the management server 20 includes a configuration part 21, a configuration management part 22, a utilization management part 23, and a control part 24. Further, the management server 20 stores a use state table 100, a permission definition table 200, a configuration information table 300, a propagation table 400, a group definition table (group definition information) 500, and a user information table 600, into a memory (storage part) 28.

Note that the propagation table 400 is required in the second embodiment, and the group definition table 500 is required in the third embodiment. In the first embodiment, these tables may not be required.

The configuration part 21 configures permission information to the management server 20, the virtual server 12, the server visualization mechanism 13, the physical server 14, and the related management server 10. The permission information is the information for controlling the connection to each server, and the like, by the user. The permission information includes Administrator permission, Modifier permission, and Viewer permission. Administrator permission is the permission allowed for the execution of all operations. Modifier permission is the permission allowed for the control (which is the execution of the function of the change in the state and configuration) and the information acquisition. Viewer permission is the permission only allowed for the information acquisition.

The configuration management part 22 collects the configuration information (host name, internet protocol (IP) address, and the like) of each server. Further, the configuration management part 22 uses the configuration information table 300, which will be described below, to store the collected information.

The utilization management part 23 configures the permission information to the use state table 100. The utilization management part 23 provides an interface (GUI (Graphical User Interface), and the like) for configuring the permission information to the administrator.

NIC (Network Interface Card) 26 is a card that is used to connect to a network 27. The management server 20 connects to the physical server 14, disk array apparatus 30, and the related management server 10 through the network 27. The management server 20 may include a plurality of NICs.

The control part 24 is the main control part to control the entire management server 20. The control part 24 determines the operation based on the control information notified from each function part, and instructs the other function parts.

Details of the use state table 100, the permission definition table 200, the configuration information table 300, the propagation table 400, and the group definition table 500 will be described later.

The user information table 600 stores the authentication information (user ID, password, and the like) necessary for the user to perform information acquisition and control, directly or through the management server 20. This information is configured by the user in advance through the GUI of the management server 20, or another user interface.

Note that in the first embodiment, the configuration part 21, the configuration management part 22, and the utilization management part 23 are described as programs (management information generation programs) executed by a CPU (Central Processing Unit) 25. However, these parts may also be implemented by the hardware and firmware installed in the management server 20, or by a combination thereof. Further, the configuration part 21, the configuration management part 22, and the utilization management part 23 are stored in an auxiliary storage device included in the management server 20. Upon execution, the configuration part 21, the configuration management part 22, and the utilization management part 23 are loaded in the memory 28 and executed by the CPU 25.

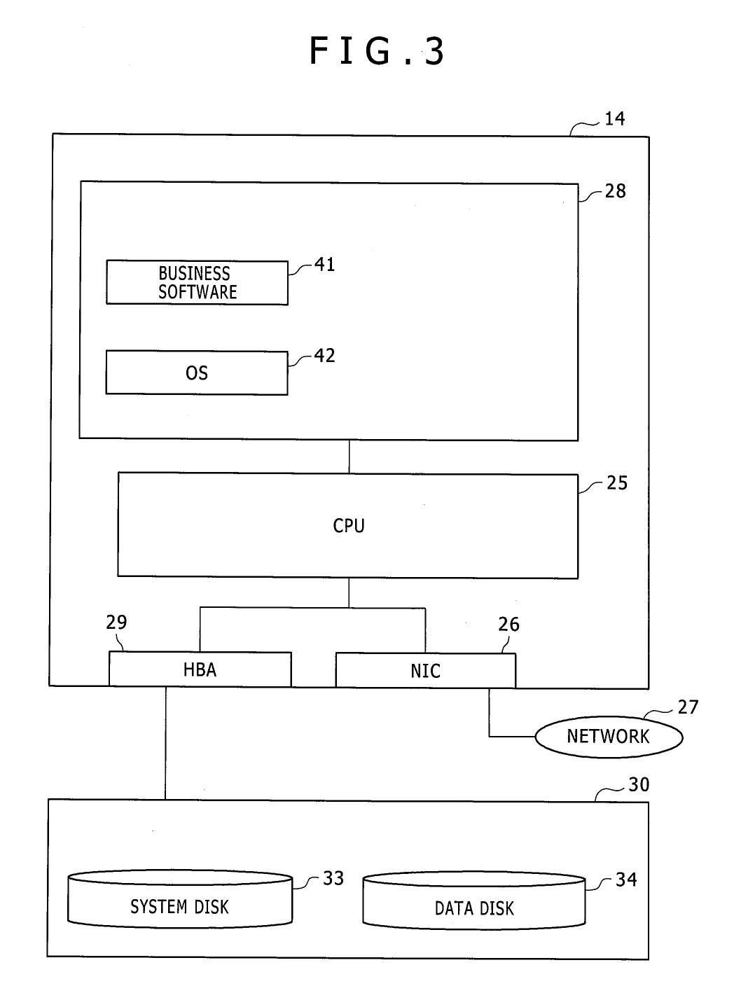

FIG. 3 is a block diagram of the physical server 14 and the disk array apparatus 30 according to the embodiment.

The physical server 14 is the computer operated by a program control. The physical server 14 is connected to the network 27 through the NIC 26. Further, the physical server 14 is connected to the disk array apparatus 30 through HBA (Host Bus Adapter) 29. Note that the physical server 14 may include a plurality of NICs 26 and a plurality of HBAs 29.

Business software 41 is the program for executing the process necessary for the operation. An operating system (OS) 42 is the basic software for controlling the physical server 14.

A system disk 33 is a disk volume containing the OS that is installed in the physical server 14. A data disk 34 is a disk volume containing data used by the virtual server 12 and the physical server 14 for the operation.

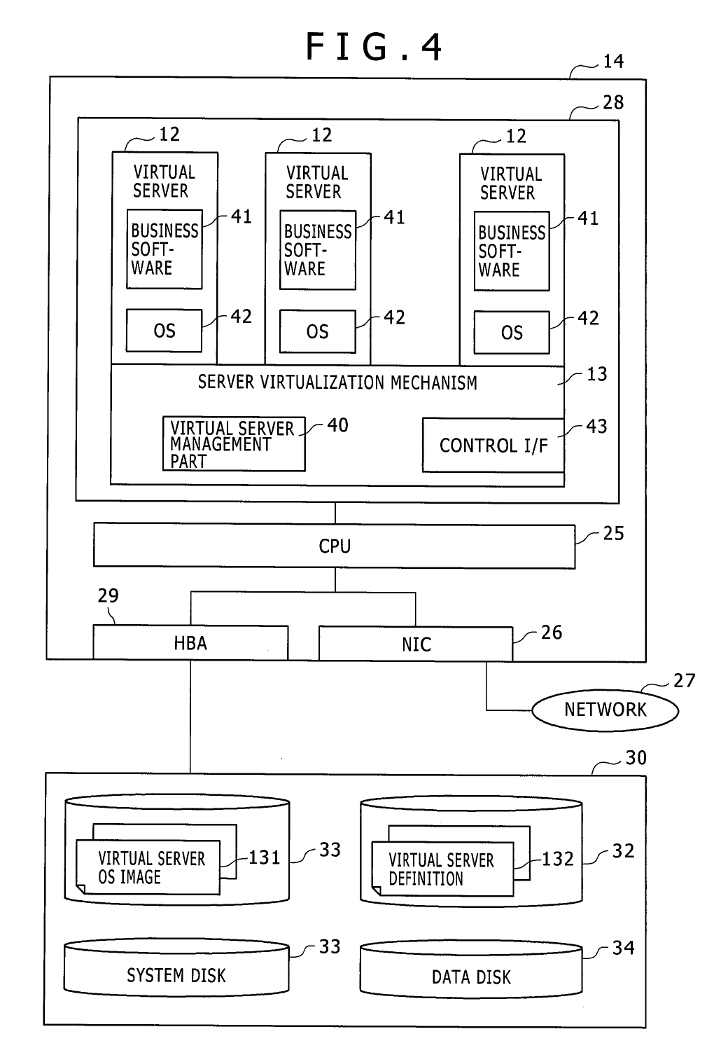

FIG. 4 is a block diagram of the physical server 14 with the virtual servers 12, and the disk array apparatus 30 according to the embodiment. The physical server 14 runs the virtual servers 12 and the server virtualization mechanism 13, on the physical server 14.

The server virtualization mechanism 13 includes a virtual server management part 40 and a control I/F (Interface) 43.

The virtual server management part 40 collects, stores, and updates the load information of the virtual servers 12, the information about the configuration, and the state information. The load information is, for example, the information on the CPU usage, the memory usage, and the like. The information about the configuration is, for example, the information on the type of OS, the assigned virtual device, and the like. The state information is the information on the power source, enabled/disabled device, and the presence of a device failure.

The control I/F 43 provides an access for the virtual server management part 40 to the outside (the management server 20, each server, and the like).

One or more virtual servers 12 run on the server virtualization mechanism 13.

The virtual server 12 is a hypothetical server device that runs with the resources of the physical server 14 assigned by the server virtualization mechanism 13. The business software 41 and the OS 42 run in the virtual server 12. Further, other server virtualization mechanisms 13 may also run within the virtual server 12.

The disk array apparatus 30 also includes a virtual server image storage disk 31 and a definition information storage disk 32.

The virtual server image storage disk 31 is a disk volume containing a virtual server OS image 131 which is a disk image of the virtual server 12. The definition information storage disk 32 is a disk volume containing a virtual server definition 132 that describes the contents of the OS installed into the virtual server 12, as well as the CPU, the memory, and the like, which are hypothetical devices assigned to the virtual server 12.

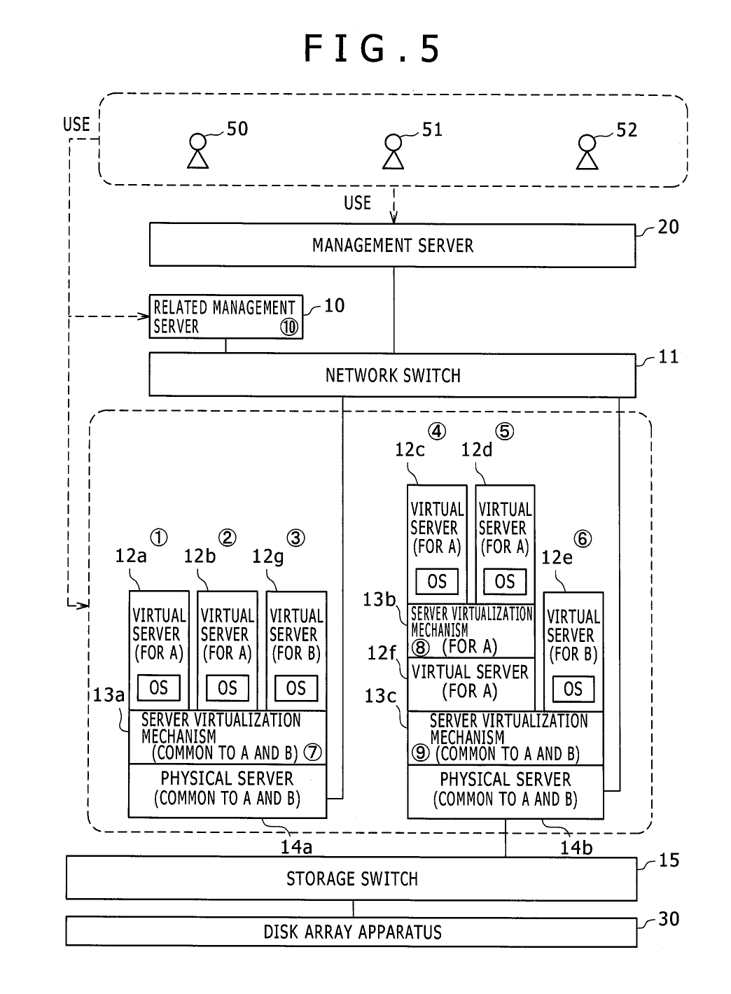

FIG. 5 is a diagram of the use of the management information generation system 1 according to the embodiment.

The management information generation system 1 assumes an administrator 50, a user A51, and a user B52 as the users of this system. The administrator 50 is a person who manages the whole system. In general, each system has one administrator but may have a plurality of administrators. The users A51 and B52 are persons who perform the management operation on behalf of the administrator 50. It is also possible that the system have one user instead of two.

The administrator 50, the user A51, and the user B52 connect to the physical server 14, the virtual server 12, and the server virtualization mechanism 13, through the management server 20 or the related management server 10, or directly, to use the functions (information acquisition, state change, configuration change, and the like) required for the management operation. The functions that the administrator 50, the user A51, and the user B52 can use in the connected device are determined based on the permission configured for each device.

The administrator 50 can use all the functions for all the devices. Further, the user A51 and the user B52 can use all or part of the functions for a part of the system. For example, the user B52 may not connect to the virtual server (for A) 12a whose permission is configured only for the user A51. Further, both the user A51 and the user B52 can connect to the server virtualization mechanism (common to A and B) 13a whose permission is configured for both the user A51 and the user B52. The administrator 50 determines the range of the functions that the user A51 and the user B52 can use for the device, based on the management policy in advance.

### Use State Table 100

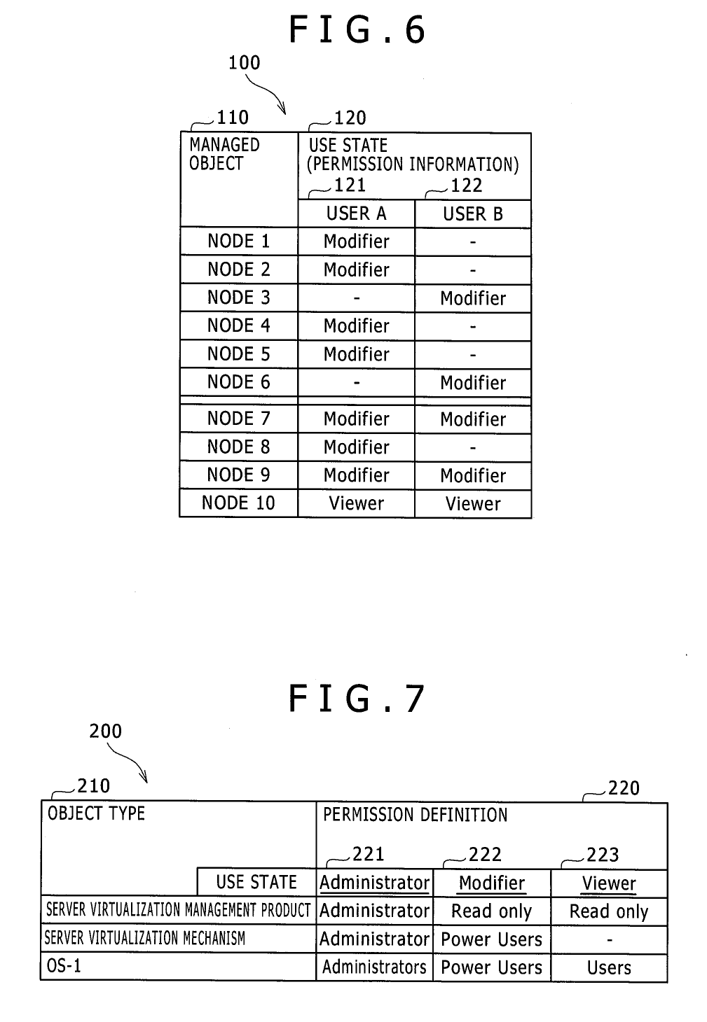

Next, the use state table 100 will be described with reference to FIG. 6.

FIG. 6 is a view of an example of the use state table 100 according to the embodiment.

The use state table 100 stores the permission information necessary for the user (administrator) to connect to each server through the management server 20. A managed object field 110 stores the identifier for identifying each server. Note that in the present specification, the managed object is the device to which the management information is configured. For example, the managed object includes the physical server 14 managed by the management server 20, the virtual server 12, the server virtualization mechanism 13, and the related management server 10. Here, the management information is the concept including the permission information. A use state (permission information) field 120 stores the permission information for each user with respect to the managed object. The first embodiment includes a user A field 121 and a user B field 122 to store the permission information for each user.

For example, in the case in which Modifier permission is configured for the user A field 121 corresponding to the record of node 1 for the managed object field 110 in the table 100, Modifier permission is configured for the user A51 with respect to the node 1. In this case, the user A51 can control the node 1 and obtain information from the node 1 by using the management server 20. Similarly, in the case in which Viewer permission is configured for the user A51 with respect to node 10, the user A51 can only obtain information from the node 10 by using the management server 20. If no permission is configured for the user A51 with respect to node 3, the user A51 may not connect to the node 3 by using the management server 20.

The user adds an initial record to the use state table 100 based on the operation management policy. For example, the user configures in advance the permission information for the nodes 1 to 6 (the virtual servers 12a, 12b, 12g, 12c, 12d, 12e) (circle numbers 1 to 6 in FIG. 5). The nodes 1 to 6 are the servers in which the business software runs. Note that in the present specification and the like, the previously configured information is referred to as the previously configured management information or the previously configured permission information.

In order to manage the server in which the business software is running, it is necessary to configure the permission information also for the nodes 7 to 10 (the server virtualization mechanisms 13a, 13b, 13c, and the related management server 10) (circle numbers 7 to 10 in FIG. 5), which are the system infrastructure of the particular server.

For example, as shown in FIG. 5, the nodes 1 and 2 for which the user A51 has Modifier permission, as well as the node 3 for which the user B52 has Modifier permission, are present in a child node of the node 7 (the server virtualization mechanism 13a) (circle number 7 in FIG. 5). The nodes 1, 2, and 3 are the virtual machines, so that the control instruction to the nodes 1 to 3 supported by Modifier permission should be executed through the node 7 which is the server virtualization mechanism. In other words, in the node 7, the control instruction to the nodes 1 to 3 is once trapped to check whether the user has the permission to execute the instruction, regardless of the permission for the nodes 1 to 3 to be controlled. Thus, the user A51 and the user B52 should have Modifier permission for the node 7.

The permission information of the nodes 7 to 10 is configured by the configuration part 21 of the management server 20 based on the initial record of the state table 100, the type of the node (object type), and the information on the parent-child relationship between nodes (parent information).

In other words, the user configures the permission information for the nodes 1 to 6, which are the children, in advance. Then, the configuration part 21 of the management server 20 automatically configures the permission information for the nodes 7 to 10 which are the parents. In this way, it is possible to effectively generate the management information appropriate for a plurality of servers. The details of this will be described below.

### Permission Definition Table 200

Next, the permission definition table 200 will be described with reference to FIG. 7.

FIG. 7 is a view of an example of the permission definition table 200.

The permission definition table 200 stores the information associated with the permission information defined by the management server 20 and the permission information defined by each server.

An object type field 210 stores the object type which is an identifier for identifying the type of each server. It is assumed that the same permission information is defined for the same server type. A permission definition field 220 stores the permission definition. The permission definition is the permission information described differently for each product. In general, the permission definition is defined in advance for each product. The permission information represents the abstract permission definition.

For example, as shown in FIG. 7, the administrator permission field 221, the modifier permission field 222, and the viewer permission field 223 are configured in the use state field. For example, if it is configured to give Modifier permission to the user for a server virtualization management product, the necessity to configure Read only permission is shown on the server virtualization management product.

### Configuration Information Table 300

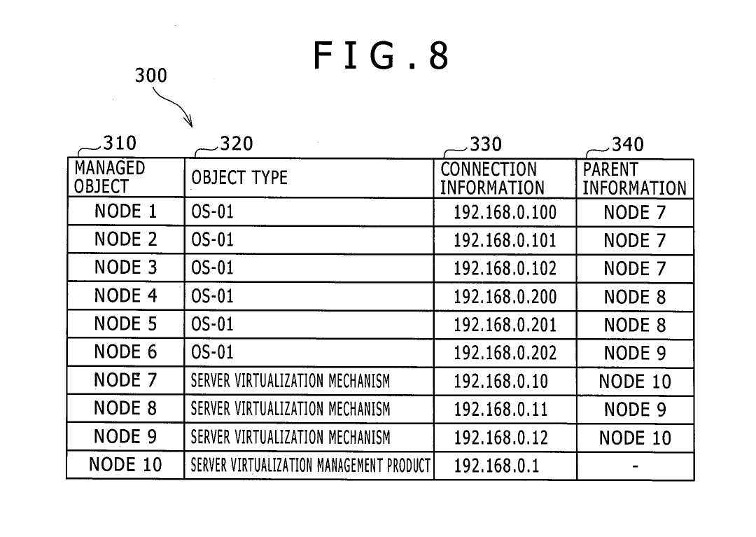

Next, the configuration information table 300 will be described with reference to FIG. 8.

FIG. 8 is a view of an example of the configuration information table 300 according to the embodiment.

The configuration information table 300 stores the object type of each server to which the management server 20 connects, the connection information, and the configuration information. The configuration management part 22 obtains these information resources from each server periodically, and updates the configuration information table 300.

A managed object field 310 stores the identifier for identifying each server. An object type field 320 stores the object type which is an identifier for identifying each server type. The value of the object type field 320 corresponds to the value of the object type field 210 (see FIG. 7). A connection information field 330 stores the connection information which is the information for the connection to each server. In the first embodiment, the IP address is used for the connection information. However, other information such as subnet mask, gateway, VLANID (Virtual Local Area Network IDentification), protocol type, and port number can also be included.

A parent information field 340 stores the parent information which is an identifier for identifying the parent of each server. The value of the parent information field 340 corresponds to the value of the managed object field 310. In the first embodiment, it is assumed that the parent-child relationship between servers, which is configured as the parent information, corresponds to the relationship between the managed object and the object being managed (for example, the related management server 10 and the server virtualization mechanism 13 shown in FIG. 5), and the relationship between aggregation and division of resources of one or more physical servers 14 (for example, the server virtualization mechanism 13 and the virtual server 12 shown in FIG. 5). Note that in the present specification and the like, the configuration information is the concept including the parent information.

### Process Operation (1) of the Management Server 20

Next, the process operation (1) of the management server 20 will be described with reference to FIGS. 6 to 9 (see FIG. 2 for the configuration accordingly).

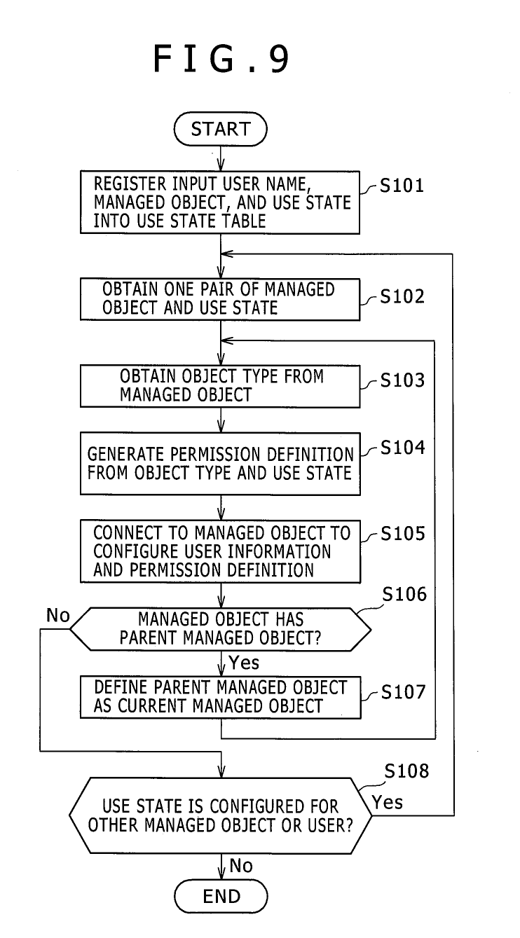

FIG. 9 is a flow chart of the process operation of the management server 20 according to the first embodiment.

First the outline of the process is given. The process is designed to use the permission information on each server configured in the management server 20, to trace the parent server of the particular server as well as the parent server of the particular parent server sequentially, in order to configure the permission for these parent servers, within the permission range corresponding to the particular permission information. Further, this process starts immediately after the respective servers are registered in the use state table 100 (see FIG. 6) as new managed objects. Note that the operation of this process can be started upon instruction from the administrator 50, or upon receiving a connection completion notification or an event signal from each server to the management server 20.

As shown in the flow chart of FIG. 9, in Step S101, the configuration part 21 registers the user name input by the user, the managed object, and the use state into the use state table 100 (see FIG. 6). Note that if all the information has been registered, this step can be omitted.

In Step S102, the configuration part 21 refers to the use state table 100 (see FIG. 6) to obtain a pair of the managed object of the managed object field 110 and the use state of the use state field 120 (hereinafter, field names and reference numerals will be omitted accordingly).

For example, as shown in FIG. 6, the configuration part 21 obtains a pair of the managed object “node 1” and the use state “Modifier” from the user A field 121 with respect to the user A51.

In Step 103, the configuration part 21 refers to the configuration information table 300 (see FIG. 8) to obtain the object type corresponding to the obtained managed object.

For example, as shown in FIG. 8, the configuration part 21 obtains the object type “OS-1” of the managed object “node 1”.

In Step S104, the configuration part 21 refers to the permission definition table 200 (see FIG. 7) to generate the permission definition from the obtained object type and the use state.

For example, as shown in FIG. 7, the configuration part 21 generates the permission definition “Power Users” from the object type “OS-1” and the use state “Modifier”.

In Step S105, the configuration part 21 refers to the configuration information table 300 (see FIG. 8) to obtain the connection information corresponding to the obtained managed object. Then, the configuration part 21 connects to the particular managed object to configure the user information and the generated permission definition, to the particular managed object. Here, the user information is the user ID (IDentification) and the password that are stored in the user information table 600 (see FIG. 2).

For example, as shown in FIG. 8, the configuration part 21 obtains the connection information “192.168.0.100” of the managed object “node 1”. Then, the configuration part 21 connects to the managed object “node 1” (the virtual server 12a in FIG. 5), and configures the user information and the permission definition “Power Users” to the managed object “node 1”.

In Step S106, the configuration part 21 determines whether the obtained managed object has a parent node. In other words, the configuration part 21 refers to the configuration information table 300 (see FIG. 8) to determine whether the parent information corresponding to the obtained managed object is configured.

For example, as shown in FIG. 8, the “node 7” is configured in the parent information corresponding to the managed object “node 1”, so that the configuration part 21 determines that the parent managed object “node 7” is present.

When it is determined that the parent managed object is present (Yes in Step S106), the configuration part 21 defines the particular parent managed object as the current managed object in Step 107. Then, the process returns to Step S103 to repeat the same process. In other words, the configuration part 21 obtains the object type of the particular parent managed object (Step S103), and generates the permission definition from the obtained object type and use state (Step S104). Then, the configuration part 21 connects to the particular parent managed object to configure the user information and the permission definition (Step S105). At the same time, the configuration part 21 also configures the permission information corresponding to the permission definition, to the use state table 100 (see FIG. 6). Then, the configuration part 21 determines whether the particular parent managed object has its parent managed object (Step S106). After the determination, the configuration part 21 repeats the same process.

For example, as shown in FIG. 8, the configuration part 21 obtains the object type “server virtualization mechanism” of the managed object “node 7”. Then, as shown in FIG. 7, the configuration part 21 generates the permission definition “Power Users” from the object type “server virtualization mechanism” and the use state “Modifier”. Then, the configuration part 21 connects to the managed object “node 7” to configure the user information and the permission definition “Power Users”. Note that when the permission definition is “-” (null value), the configuration part 21 does not connect to the managed object and does not configure the permission definition.

Then, the configuration part 21 configures the permission information “Modifier” corresponding to the permission definition “Power Users”, with respect to the managed object “node 7” of the user A51 of the use state table 100 (see FIG. 6). Next, the configuration part 21 refers to FIG. 8 to determine that the managed object “node 7” has its parent managed object “node 10”. Then, the configuration part 21 refers to FIG. 8 to obtain the object type “server virtualization management product” of the managed object “node 10”. Then, the configuration part 21 refers to FIG. 7 to generate the permission definition “Read only” from the object type “server virtualization management product” and the use state “Modifier”. The configuration part 21 connects to the managed object “node 10” to configure the user information and the permission definition “Read only”. Then, the configuration part 21 configures the permission information “Viewer” corresponding to the permission definition “Read only”, with respect to the managed object “node 10” of the user A51 of the use state table 100 (see FIG. 6).

On the other hand, if it is determined that the parent managed object is not present (No in Step S106), in Step S108, the configuration part 21 refers to the use state table 100 (see FIG. 6) to determine whether the use state is configured for the other managed object or user.

If it is determined that the use state is configured for the other managed object or user (Yes in Step S108), the process returns to Step S102. Then, the configuration part 21 repeats the same process.

On the other hand, if it is determined that the use state is not configured for the other managed object or user (No in Step S108), the configuration part 21 ends the process.

According to the first embodiment, it is possible to use the use state 120 (the permission information) of each server configured in the management server 20, to trace the parent server of the particular server as well as the parent server of the particular parent server sequentially, in order to configure the permission for these parent servers, within the permission range corresponding to the particular permission information.

### Second Embodiment

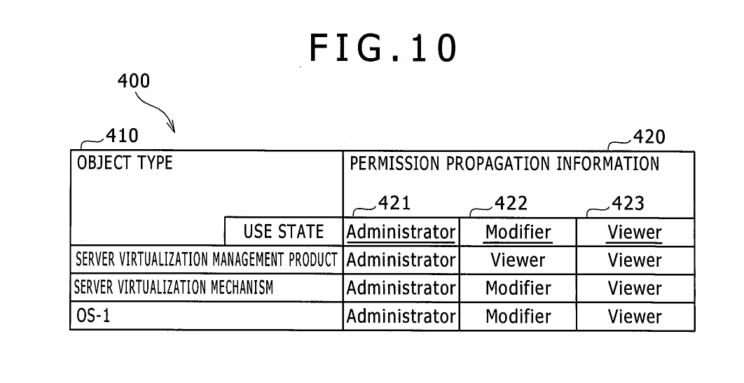

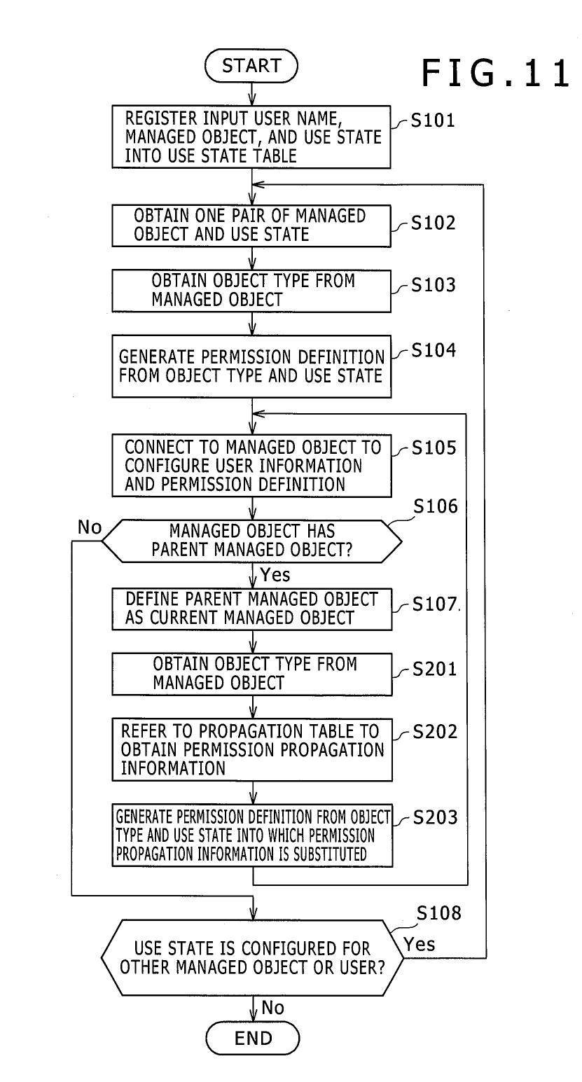

Next, the second embodiment of the present invention will be described with reference to FIGS. 10 and 11 (see FIG. 2 for the configuration accordingly).

In the first embodiment, it is assumed that the permission information equivalent to the permission information configured in the management server 20, is configured for each server. However, the second embodiment takes into account that the permission range is different between the permission information configured for a certain server and the permission information configured for the parent server of the particular server. In other words, if the permission information is configured for the parent server of a certain server, the permission may be configured with a smaller permission range. For example, there is a case in which the Modifier permission is desired to be configured for the server virtualization mechanism but the Viewer permission is desired to be configured for the server virtualization management product which is the parent of the server virtualization mechanism. In order to solve this problem, in the second embodiment, the management server 20 also includes the propagation table 400 which will be described below (see FIG. 2).

### Propagation Table 400

The propagation table 400 will be described with reference to FIG. 10.

FIG. 10 is a view of an example of the propagation table 400 according to the second embodiment.

By using the propagation table 400, it is possible to configure the permission information of the permission range different from the permission information configured in the management server 20, for each object type.

An object type field 410 stores the object type which is an identifier for identifying the type of each server. The value of the object type field 410 corresponds to the value of the object type field 320 (see FIG. 8). A permission propagation information field 420 stores the permission propagation information corresponding to the use state, which is the permission information configured in the management server 20, for each object type. The value of the permission propagation information field 420 is determined by the administrator (user) in advance. The use state field includes an administrator permission field 421, a modifier permission field 422, and a viewer permission field 423. When the number of value types in the use state field increases, it is possible to increase the number of columns of the use state field for the additional types.

The permission information is configured in such a way that the permission information is propagated sequentially to each server based on the propagation table 400. This operation will be described below.

### Process Operation (2) of the Management Server 20

The process operation (2) of the management server 20 will be described with reference to FIGS. 10 and 11 (see FIG. 2 for the configuration accordingly).

First the outline of the process is given. The process is designed to use the permission information (see FIG. 6) for each server configured in the management server 20, to trace the parent server of a certain server as well as the parent server of the particular parent server sequentially, in order to configure the permission for these parent servers, within the permission range corresponding to the particular permission information or within a different permission range.

FIG. 11 is a flow chart of the process operation of the management sever 20 according to the second embodiment. In this flow chart, the process of steps S101 to S107 and S108 is the same as the process of steps S101 to S107 and S108 in the flow chart of FIG. 9. Thus, the same step numbers are assigned to the corresponding steps and the description thereof will be omitted. Here, the process of steps S201 to S203 will be described.

As shown in the flow chart of FIG. 11, in Step S201, the configuration part 21 refers to the configuration information table 300 (see FIG. 8) to obtain the object type of the parent stored in the parent information 340 of the managed object.

For example, as shown in FIG. 8, the configuration part 21 obtains the object type “server virtualization mechanism” of the managed object “node 7”.

In Step S202, the configuration part 21 refers to the propagation table 400 (see FIG. 10) to obtain the permission propagation information from the obtained object type and the use state.

For example, as shown in FIG. 10, the configuration part 21 obtains the permission propagation information “Modifier” from the object type “server virtualization mechanism” and the use state “Modifier”.

In Step S203, the configuration part 21 substitutes the obtained permission propagation information into the use state. Then, the configuration part 21 refers to the permission definition table 200 (see FIG. 7) to generate the permission definition from the obtained object type and the use state. Then, the process returns to Step S105.

For example, as shown in FIG. 7, the configuration part 21 substitutes the obtained permission propagation information “Modifier” into the use state, and generates the permission definition “Power Users” from the object type “server virtualization mechanism” and the use state “Modifier”. Then, the configuration part 21 connects to the managed object “node 7” to configure the user information and the permission definition “Power Users”.

Then, similarly, the configuration part 21 determines that the managed object “node 7” has its parent managed object “node 10” (Yes in Step S106). Then, the configuration part 21 obtains the object type “server virtualization management product” of the managed object “node 10” (Step S201). The configuration part 21 refers to the propagation table 400 (see FIG. 10) to obtain the permission propagation information “Viewer” from the object type “server virtualization management product” and the use state “Modifier” (Step S202). Then, the configuration part 21 substitutes the obtained permission propagation information “Viewer” into the use state, and generates the permission definition “Read only” from the object type “server virtualization management product” and the use state “Viewer” by referring to the permission definition table 200 (see FIG. 7) (Step S203). Then, in Step S105, the configuration part 21 connects to the managed object “node 10” to configure the user information and the permission definition “Read only”.

According to the second embodiment, it is possible to use the permission information for the server configured in the management server 20, to trace the parent server of the particular server as well as the parent server of the particular parent server sequentially, in order to configure the permission for these parent servers, within the permission range smaller than the permission information of the child server.

### Third Embodiment

Next, the third embodiment of the present invention will be described with reference to FIGS. 5, 12, and 13 (see FIG. 2 for the configuration accordingly).

The third embodiment takes into account the state in which each server belongs to a group. The group is defined by the administrator, the users, the management server 20, and the related management server 10 for the purpose of load distribution, fail over, and the like.

For example, the node 3 (the virtual server (for B) 12g) (circle number 3 in FIG. 5) may be moved to the node 8 (the server virtualization mechanism (for A) 13b) (circle number 8 in FIG. 5) for load distribution or fail over. The node 8 should be common to A and B immediately after the node 3 is moved to the node 8. In other words, it is necessary to configure the permission for the user B52 to the node 8 in advance.

In order to solve this problem, the permission for the user B52 is configured in advance so that the node 3 and the node 8 belong to the same group. In this way, it is possible to configure the permission for the user B52 not only to the node 3 but also to the node 8.

Further, if the node 1 is generally used but the node 7 is used in case of failure, it is necessary to configure the same permission as the node 1 also to the node 7 in advance.

In order to solve this problem, the node 1 and the node 7 are configured so as to belong to the same group, so that the permission is automatically configured for the node 7 in addition to the node 1.

Thus, in the third embodiment, the management server 20 also includes the group definition table 500 which will be described below (see FIG. 2).

### Group Definition Table 500

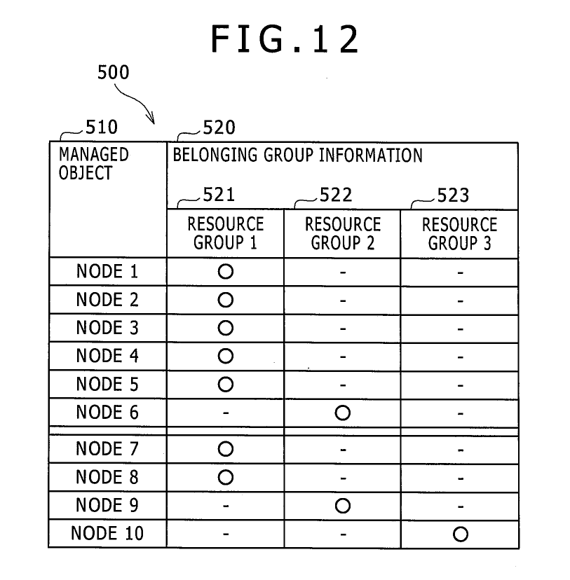

The group definition table 500 will be described with reference to FIG. 12.

FIG. 12 is a view of an example of the group definition table 500 according to the third embodiment.

The group definition table 500 stores the information on the grouping of each server managed by the management server 20.

A managed object field 510 stores the identifier for identifying each server. The value of the managed object field 510 corresponds to the values of the managed object fields 110 and 310. A belonging group information field 520 indicates the group to which each server belongs. In the third embodiment, the belonging group information field 520 includes a resource group 1 field 521, a resource group 2 field 522, and a resource group 3 field 523. When the number of groups required to be configured increases, it is possible to increase the number of columns of the group field for the additional number of groups.

Note that in the third embodiment, it is assumed that the management server 20 holds all the contents of the group definition table 500, and the configuration management part 22 generates and updates the value of the belonging group information field 520. Note that if part of the information is managed by the related management server 10 for management load distribution, the management server 20 may obtain the information from the related management server 10 each time when it is necessary.

### Process Operation (3) of the Management Server 20

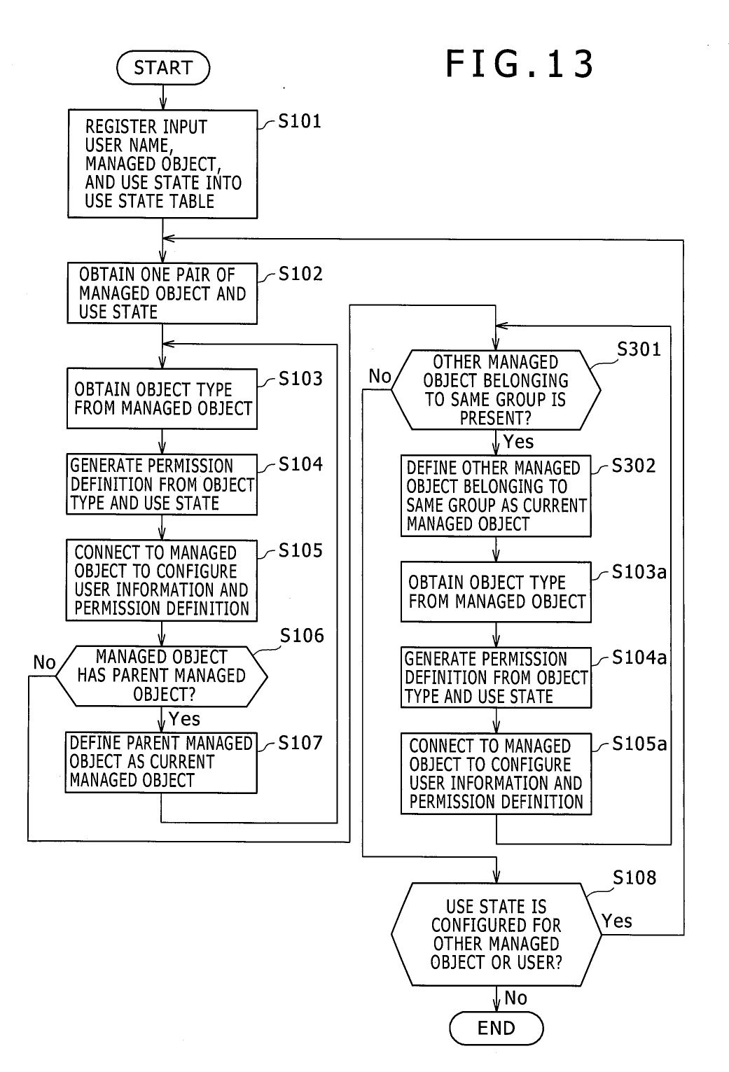

Next, the process operation (3) of the management server 20 will be described with reference to FIGS. 12 and 13 (see FIG. 2 for the configuration accordingly).

First the outline of the process is given. The process is designed to use the permission information (see FIG. 6) on each server configured in the management server 20, in order to configure the permission for the other server belonging to the same group as a certain server, within the permission range corresponding to the permission information of the other server.

FIG. 13 is a flow chart of the process operation of the management server 20 according to the third embodiment. In this flow chart, the process of steps S101 to S107 and S108 is the same as the process of steps S101 to S107 and S108 in the flow chart of FIG. 9, so that the same step numbers are assigned to the corresponding steps and the description thereof will be omitted. Here, the process of steps S301 and S302 will be described.

As shown in the flow chart of FIG. 13, in Step S301, the configuration part 21 determines whether there is the other managed object belonging to the same group to which the managed object obtained in Step S102 belongs.

If it is determined that the other managed object belonging to the same group is present (Yes in Step S301), in Step S302, the configuration part 21 defines the particular other managed object as the current managed object. Then, similarly, the configuration part 21 connects to the particular other managed object to configure the user information and the permission definition (Steps S103a to S105a). Note that the process of steps S103a to S105a is the same as the process of steps S103 to S105.

On the other hand, if it is determined that there is no other managed object belonging to the same group (No in Step S301), the process proceeds to Step S108.

For example, as shown in FIG. 12, the configuration part 21 determines the presence of the other managed object “node 2 (node 3 to 5, 7, or 8)” belonging to the same group as the group “resource group 1” to which the managed object “node 1” obtained in Step S102 belongs (Step S301). Then, the configuration part 21 defines the “node 2” as the managed object (Step S302). Then, similarly, the configuration part 21 refers to the configuration information table 300 (see FIG. 8) to obtain the object type “OS-1” of the managed object “node 2” (Step S103a). Then, the configuration part 21 refers to the permission definition table 200 (see FIG. 7) to generate the permission definition “Power Users” from the object type “OS-1” and the use state “Modifier” (Step S104a). Then, the configuration part 21 refers to the configuration information table 300 (see FIG. 8) to obtain the connection information “192.168.0.101” of the obtained managed object “node 2”. Then, the configuration part 21 connects to the managed object “node 2” to configure the user information and the generated permission definition “Power Users”, to the managed object “node 2” (Step S105a).

According to the third embodiment, it is possible to use the permission information (see FIG. 6) on each server configured in the management server 20, to trace the parent server of a certain server as well as the parent server of the particular parent server sequentially, in order to configure the permission for these parent servers, within the permission range corresponding to the particular permission information.

Further, it is also possible to use the permission information on each server configured in the management server 20, in order to configure the permission for the other server belonging to the same group as a certain server, within the permission range corresponding to the permission information of the other server.

### Fourth Embodiment

Process Operation (4) of the Management Sever 20

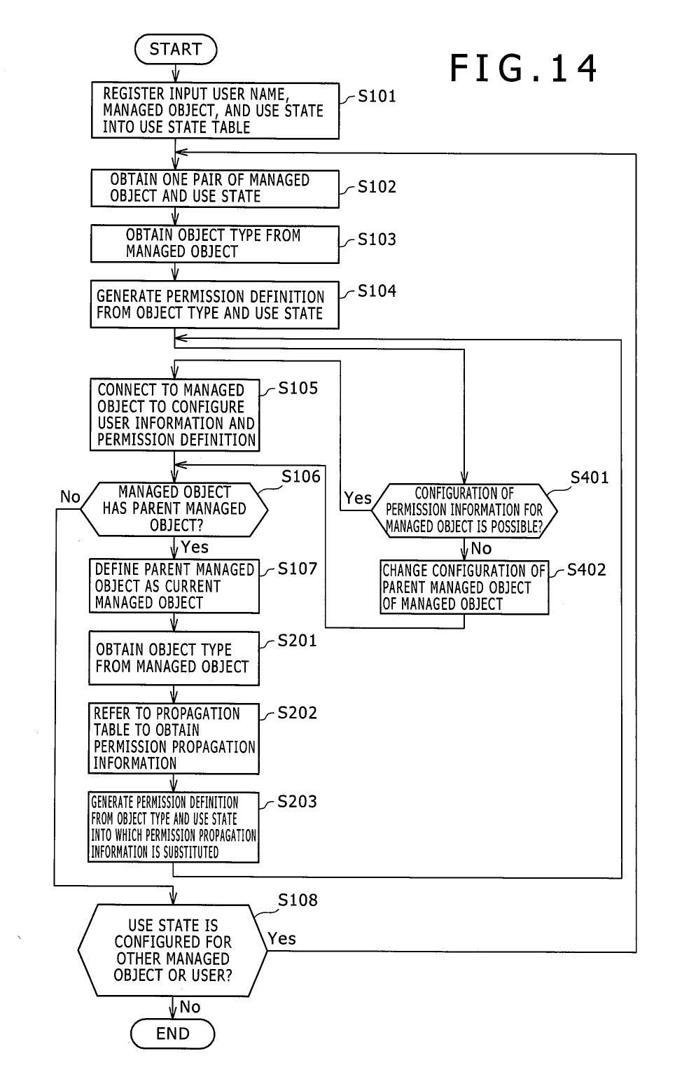

Next, the process operation (4) of the management server 20 according to the fourth embodiment will be described with reference to FIG. 14 (see FIG. 2 for the configuration accordingly).

First the outline of the process is given. The process is designed to limit the user permission when the permission information may not be configured for a certain server, by changing the configuration of the parent managed object of the particular managed object.

FIG. 14 is a flow chart of the process operation of the management server 20 according to the fourth embodiment. In this flow chart, the process of steps S101 to S104, S105 to S107, S108, and S201 to S203 is the same as the process of steps S101 to S104, S105 to S107, S108, and S201 to S203 in the flow chart of FIG. 11. Thus, the same step numbers are assigned to the corresponding steps and the description thereof will be omitted. Here, the process of steps S401 and S402 will be described.

As shown in the flow chart of FIG. 14, in Step S401, the configuration part 21 determines whether the configuration of the permission information for the managed object is possible. This determination is performed based on the object type of the managed object, the permission definition, the function list of the server, and the like. For example, the configuration part 21 determines that the configuration of the permission information may not be possible if the null value “-” is assigned to the permission definition table 200.

When it is determined that the configuration of the permission information for the managed object is possible (Yes in Step S401), the configuration part 21 configures the user information and the permission definition to the managed object in Step S105.

On the other hand, if it is determined that the configuration of the permission information for the managed object may not be possible (No in Step S401), in Step S402, the control part 24 changes the configuration of the parent managed object of the particular managed object. Here, the configuration of the permission information for the managed object may not be possible, which means the case in which the managed object does not include an interface to configure the user name and the permission information from the outside, or the case in which the permission definition is not present from the beginning. Further, the change in the configuration of the managed object is partitioning, migration of the server, the change from the physical server to the virtual server, and the like. In this way, it is possible to obtain the same effect as the limitation or change of the access rights of the user.

For example, in FIG. 5, it is assumed that the permission information may not be configured for the node 8 represented by circle number 8 (the server virtualization mechanism 13b). At this time, the default configured user name and the permission information (for example, root) are used for the node 8, so that unnecessary permission may be given to the user. In this case, the node 9 (the server virtualization mechanism 13c), which is the parent node of the node 8, is partitioned to limit the access rights of the user to the node 8.

According to the fourth embodiment, if the permission information may not be configured for a certain server, it is possible to limit the permission of the user by changing the configuration of the parent managed object of the particular managed object.

### VARIATIONS

Although exemplary embodiments of the present invention have been described hereinabove, it should be understood that the present invention is not limited to these embodiments, but may be modified by those skilled in the art without departing from the spirit and scope of the present invention.

For example, in the description of the first to fourth embodiments, the permission information is used. However, the present invention can also be applied to other information such as control information and authentication information. It should be noted that in the present specification, these information resources are collectively referred to as the management information.

Further, in the foregoing embodiments of the present invention, it is assumed that the processes are performed in the order of steps in the respective flow charts chronologically, but the process steps are not necessarily processed chronologically, and processes that are performed in parallel or individually are also included in the present invention.

Further, appropriate combinations of the components disclosed in the above embodiments can form various inventions. For example, it is possible to delete some components from all the components shown in the exemplary embodiment. Further, it may be appropriately combined components in different embodiments.

### LIST OF REFERENCE SIGNS

1. Management information generation system
10. Related management server (Managed object)
11. Network switch
12. Virtual server (Managed object)
13. Server virtualization mechanism (Managed object)
14. Physical server (Managed object)
15. Storage switch
20. Management server (Management information generation apparatus)
21. Configuration part
22. Configuration management part
23. Utilization management part
24. Control part
25. CPU
26. NIC
27. Network
28. Memory (Storage part)
30. Disk array apparatus
31. Virtual server image storage disk
32. Definition information storage disk
33. System disk
34. Data disk
40. Virtual server management part
41. Business software
50. Administrator
100. Use state table (Management information)
131. Virtual server OS image
132. Virtual server definition
200. Permission definition table
300. Configuration information table (Configuration information)
400. Propagation table
500. Group definition table (Group definition information)
600. User information table

1. A management information generation method for a management information generation apparatus in a system including a plurality of managed objects, to generate management information for the managed objects,
wherein a control part of the management information generation apparatus stores the configuration information of the managed objects in the system, as well as the management information previously configured for some managed objects of the plurality of managed objects, into a storage part, and
wherein a configuration part of the management information generation apparatus generates the management information for the other managed objects of the plurality of managed objects by using the configuration information and the previously configured management information.

2. A management information generation method according to claim 1,
wherein the management information is the permission information of the user for the managed object.

3. A management information generation method according to claim 2,
wherein the configuration part refers to the configuration information to generate the permission information as the permission information for the parent managed object of the particular managed object, within the permission range corresponding to the particular permission information.

4. A management information generation method according to claim 3,
wherein the configuration part generates the permission information as the permission information for the parent managed object, within the permission range different from the permission information for the child managed object of the particular parent managed object.

5. A management information generation method according to claim 2,
wherein the control part also stores group definition information used for dividing the plurality of managed objects into predetermined groups, into the storage part, and
wherein the configuration part refers to the group definition information to generate the permission information for the other managed object belonging to the same group as the managed object for which the permission information has been configured.

6. A management information generation method according to claim 2,
wherein if the permission information may not be configured for the managed object, the control part limits the permission of the user by changing the configuration of the parent managed object of the particular managed object.

7. A management information generation method according to claim 2,
wherein the configuration information holds the connection information to the managed object, and
wherein the configuration part connects to the particular managed object based on the connection information, to configure the generated permission information for the particular managed object.

8. A management information generation program that allows a computer to execute the management information generation method according to claim 1.

9. A management information generation apparatus in a system including a plurality of managed objects to generate management information for the managed object, the management information generation apparatus comprising:
a storage part for storing configuration information of the managed objects in the system, and management information previously configured for some managed objects of the plurality of managed objects; and
a configuration part for generating management information for other managed objects of the plurality of managed objects by using the configuration information and the previously configured management information.

10. A management information generation apparatus according to claim 9,
wherein the management information is the permission information of the user for the managed object.

11. A management information generation apparatus according to claim 10,
wherein the configuration part refers to the configuration information to generate the permission information as the permission information for the parent managed object of the particular managed object, within the permission range corresponding to the particular permission information.

12. A management information generation apparatus according to claim 11,
wherein the configuration part generates the permission information as the permission information for the parent managed object, within the permission range different from the permission information for the child managed object of the particular parent managed object.

13. A management information generation apparatus according to claim 10,
wherein the storage part also stores group definition information used for dividing the plurality of managed objects into predetermined groups, and
wherein the configuration part refers to the group definition information to generate the permission information for the other managed object belonging to the same group as the managed object for which the permission information has been configured.

14. A management information generation apparatus according to claim 10, further comprising a control part for limiting the permission of the user by changing the configuration of the parent managed object of the managed object, if the permission information may not be configured for the particular managed object.
